(19) United States
(12) Patent Application Publication
(10) Pub. No.: US 2016/0150035 A1
(43) Pub. Date: May 26, 2016

(54) SHARING APPLICATION FOR A MOBILE DEVICE

(71) Applicants: John W. Melstrom, JR., Rochester, MI (US); Fred Jeffrey Parr, New Baltimore, MI (US)

(72) Inventors: John W. Melstrom, JR., Rochester, MI (US); Fred Jeffrey Parr, New Baltimore, MI (US)

(21) Appl. No.: 14/951,962

(22) Filed: Nov. 25, 2015

Related U.S. Application Data
(60) Provisional application No. 62/084,664, filed on Nov. 26, 2014.

(51) Int. Cl. H04L 29/08; H04L 12/58; H04W 4/02

(52) U.S. Cl. CPC H04L 67/18; H04W 4/021; H04L 67/306; H04L 51/10

(57) ABSTRACT

An aspect of the present disclosure provides a system and a content sharing mobile application for sharing media content. Another aspect of the present disclosure provides a method of sharing media content using a mobile device. The content sharing mobile application may be configured to allow one or more users to create a shared space based on the user's location, upload media content to the shared space, and to allow the user to view the media content based on the user's or individual's location.

### CROSS-REFERENCE TO RELATED APPLICATIONS

The present application claims priority to U.S. Provisional Application No. 62/084,664 filed on Nov. 26, 2014, and is hereby incorporated by reference, as though set forth fully herein.

### FIELD OF THE DISCLOSURE

The present disclosure generally relates to a system and a mobile application for a mobile device and in particular, a system and a content sharing mobile application for a mobile device. The system and the content sharing mobile application can enable a user to create a shared space relative to a zone to share media content with other individuals within the zone or create a zone to share media content and allow access to certain individuals within the zone.

### BACKGROUND OF THE DISCLOSURE

In the age of the smart device and instantaneous access to content, individuals are always seeking new and efficient ways to send and receive or share media content with others. Websites and some applications have been created in response to these individual's desires. However, such websites and applications have deficiencies and are limited in sharing capabilities. For example, there are not settings with such systems that allow the user to only share with specific individuals. There is not a way for the user to create a share spaced and limit that space to a particular location and/or to particular individuals. Additionally, current websites and applications are limited in the type of media content shared such as photographs and videos.

As such, there is a need for a system and mobile application for sharing media content with individuals that addresses the deficiencies and limitation of current websites and applications.

### SUMMARY OF THE DISCLOSURE

A system and a mobile application for sharing media content, and a method of sharing media content using a mobile device are provided.

An aspect of the system may include a content sharing mobile application configured to allow a user to create a shared space for sharing media content, create a zone associated with the shared space using geo-fencing technology, and transmit media content to another user when the user is detected within the zone.

An aspect of the mobile application for sharing media content may include a shared space created by a user and a zone associated with the shared space created using geo-fencing using geo-fencing technology. The mobile application may also transmit media content to another user when the user is detected within the zone.

An aspect of the method of sharing media content may include providing a content sharing mobile application and enabling a user to create a zone to share media content using geo-fencing technology.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is an example of an aspect of a system for sharing media content in accordance with the present disclosure;

FIG. 2 is an example of another aspect of a system for sharing media content in accordance with the present disclosure;

FIG. 3 is a block diagram of a system for sharing media content in accordance with the present disclosure;

FIG. 4 is an example of an illustration of a mobile device with a content sharing mobile application in accordance with the present disclosure;

FIG. 5 is an example of an illustration of a mobile device with a live stream interface of a content sharing mobile application in accordance with the present disclosure;

FIG. 6 is an example of an illustration of a mobile device with a zone interface of a content sharing mobile application in accordance with the present disclosure;

FIG. 7 is an example of an illustration of a mobile device with a shoot interface of a content sharing mobile application in accordance with the present disclosure;

FIG. 8 is an example of an illustration of a mobile device with a grab interface of a content sharing mobile application in accordance with the present disclosure;

FIG. 9 is an example of an illustration of a mobile device with a profile interface of a content sharing mobile application in accordance with the present disclosure;

FIG. 10 is a flowchart of a method of accessing a content sharing mobile application in accordance with the present disclosure; and

FIG. 11 is a flowchart of a method of sharing media content in accordance with the present disclosure.

### DETAILED DESCRIPTION OF THE PRESENT DISCLOSURE

Detailed examples of the present disclosure are disclosed herein; however, it is to be understood that the disclosed examples are merely exemplary and may be embodied in various and alternative forms. It is not intended that these examples illustrate and describe all possible forms of the disclosure. Rather, the words used in the specification are words of description rather than limitation, and it is understood that various changes may be made without departing from the spirit and scope of the disclosure. As those of ordinary skill in the art will understand, various features of the present disclosure are illustrated and described with reference to the Figures and may be combined with features illustrated in one or more other Figures to produce examples of the present disclosure that are not explicitly illustrated or described. The combinations of features illustrated provide representative examples for typical applications. However, various combinations and modifications of the features consistent with the teachings of the present disclosure may be desired for particular applications or implementations.

An aspect of the present disclosure provides a system and a mobile application for sharing media content, and a method of sharing media content using a mobile device.

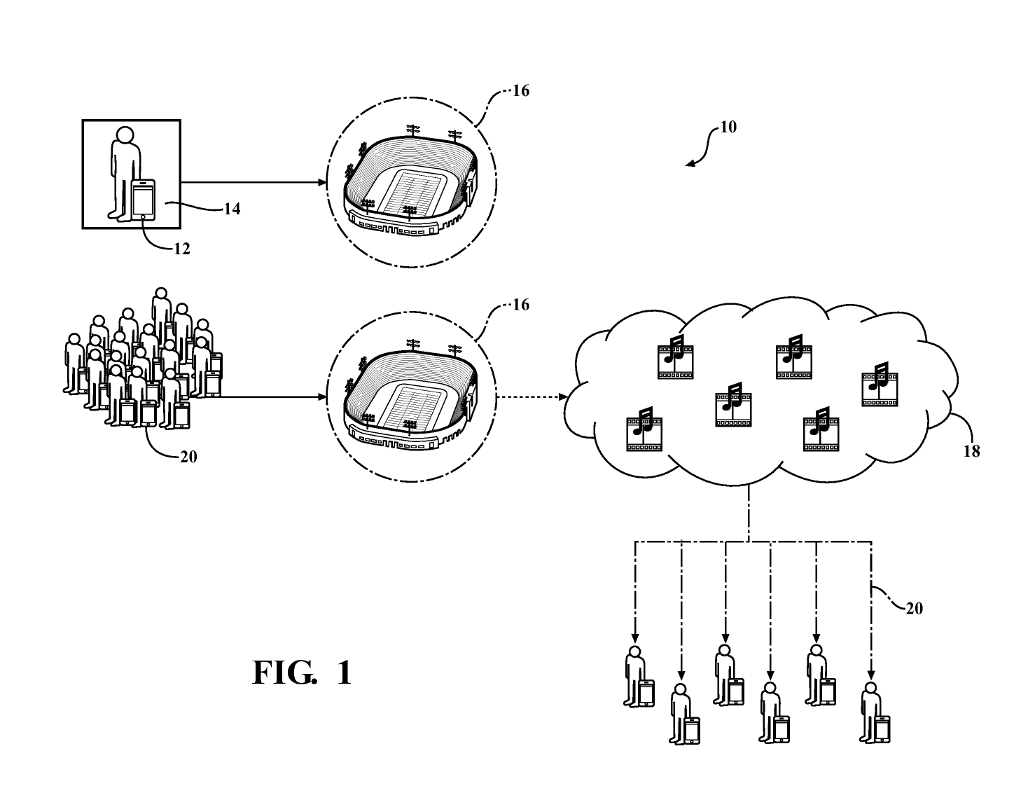

FIG. 1 is an example of an aspect of a system 10 for sharing media content in accordance with the present disclosure. The system 10 can allow one or more users to create a shared space for sharing media content based on the user's location, to upload the media content to the shared space, and to allow the users to view the media content based on their location.

The system 10 includes a mobile device 12 such as, but not limited to, a smart device, smart phone, mobile phone, tablet, smart watch, and the like. The mobile device 12 may include a user interface 14 configured to receive inputs from a user. The user interface 14 may be, but is not limited to, a touch screen and/or one or more buttons to select and control various settings or features on the mobile device 12. Such touch screen may be a liquid crystal display (LCD), a capacitive touch screen, or a resistive touch screen. The user interface 14 may also be configured to display media content such as, but is not limited to, text, text message, e-mail, mobile applications, photographs, videos, music, and the like.

The mobile device 12 may also include a controller (not shown) in communication with the user interface 14. The controller may have any combination of memory storage such as random-access memory (RAM) or read-only memory (ROM), processing resources or a microcontroller or central processing unit (CPU) or hardware or software control logic to enable management of a controller. Additionally, the controller may include one or more wireless, wired or any combination thereof of communications ports to communicate with external resources as well as various input and output (I/O) devices. The controller can also have one or more buses operable to transmit communication of management information between the various hardware components, and can communicate using wire-line communication data buses, wireless network communication, or any combination thereof. The controller may be configured to store and operate one or more mobile applications of the mobile device 12.

The system 10 may also include a content sharing mobile application 16. The content sharing mobile application 16 may allow one or more users to create a shared space based on the user's location, upload media content to the shared space, and to allow the user to view the media content based on their location. The user creating or uploading media content to the shared space may be known as a sending user and the user receiving or viewing the media content may be known as a viewing user. It will be appreciated by one skilled in the art that, in some aspects, the sending user may also view media content in which the sending user had previously uploaded. Additionally, it will also be appreciated that once the shared space is created, any user may upload media content to the shared space.

The content sharing mobile application 16 may also be configured to use geo-fencing or global positioning system (GPS) technology to create a zone in which the shared space exists. According to an aspect, the content sharing mobile application 16 may enable the user to designate or set a boundary of the zone via the geo-fencing technology or in the alternative, may enable the user to select a predetermined zone from a listing identified by GPS technology. For example, a predetermined zone may be a sports arena. It will be appreciated by one skilled in the art that the zone is the physical location in which the shared space exists and that the shared space is the location in which media content is uploaded to and viewed by the users.

According to another aspect, the content sharing mobile application 16 may also be configured to enable the user to upload media content to the shared space and to view the media content when the user is present within the zone. Media content may include, but is not limited to, photographs, videos, text, music, and the like. The content sharing mobile application 16 may further be configured to prevent the user from viewing the shared space when the user is not within the zone.

The system 10 may further include a server 18 designed to receive and store the shared space and corresponding media content uploaded to the shared space from the mobile device 12 and the content sharing mobile application 16. In another aspect, the server 18 may be in communication with multiple users via one or more mobile devices 20 through the content sharing mobile application 16 such that, a first mobile device with the content sharing mobile application 16 may upload a photograph or other media content to the shared space to the server 18 and the server 18 may then communicate with a second mobile device with the content sharing mobile application 16 and enable the user to download the photographs or other media content. Further, the server 18 may be a cloud-based or web-based server.

In operation, the system 10 may be configured to share, download, or receive media content uploaded to the shared space when the user is detected or located within the zone. The user or viewing user may be any individual within the zone which has the content sharing mobile application 16 on their mobile device 12.

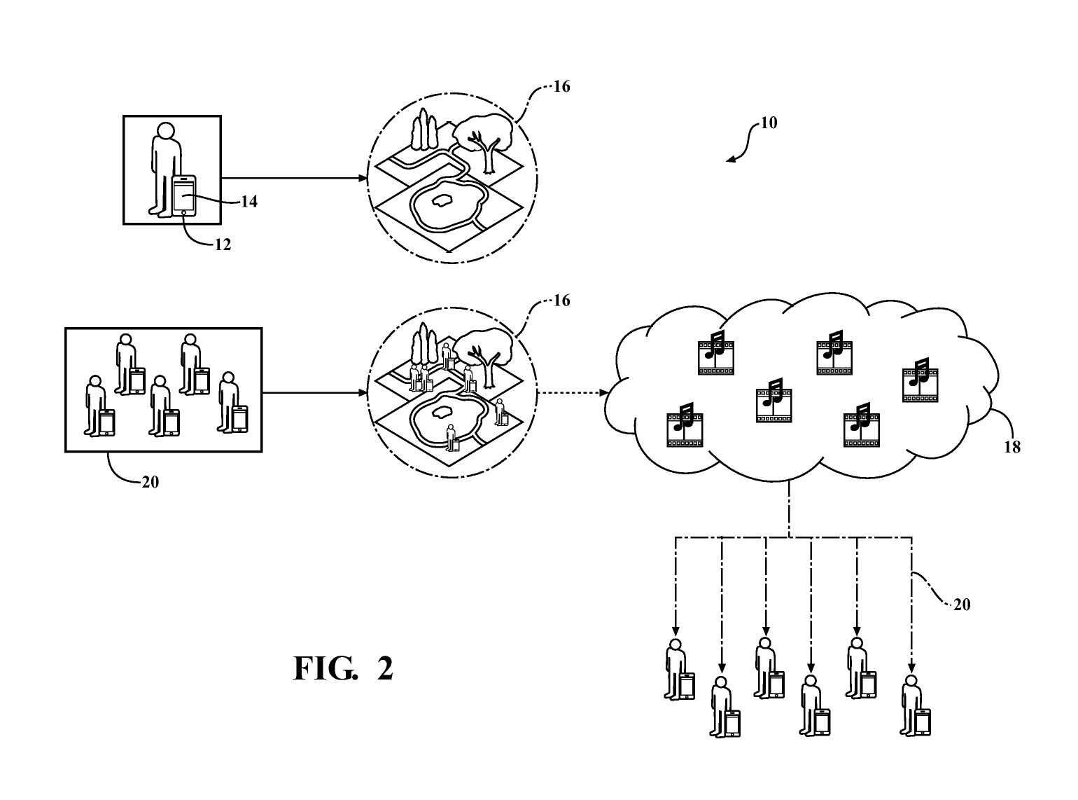

FIG. 2 is an example of another aspect of a system 10 for sharing media content in accordance with the present disclosure. The system 10 may include the mobile device 12, the content sharing mobile application 16, the server 18, and one or more mobile devices 20 as described in FIG. 1. In another aspect, as shown in FIG. 2, the system 10 may also allow the user to assign or invite other users or mobile devices 20 to view the shared space and share media content. In other words, the system 10 may only allow access to the shared space to those user's and mobile devices 20 who have been assigned to the shared space or who have been invited to the shared space i.e. the users have private access and will not be able to view any shared media content if they are not granted private access. According to another aspect, similar to FIG. 1, the content sharing application 16 and mobile devices 12 and 20 may only display the media content when the user is detected or located within the zone in which the shared space exists. The system 10 may further be configured to display the media content on the user interface 14 of the media device 12 via the content sharing mobile application 16 to the user.

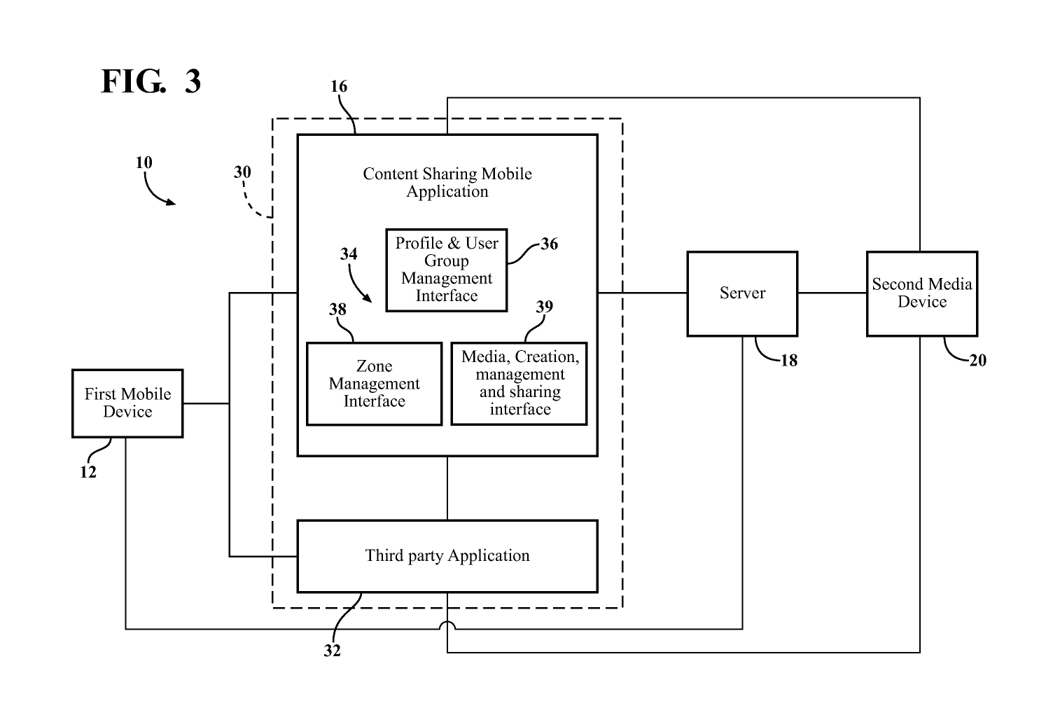

FIG. 3 is a block diagram of a system 10 for sharing media content in accordance with the present disclosure. As described above, the system 10 may include a mobile device 12 with a user interface 14. The mobile device 12 may be a first mobile device. The mobile device 12 may be configured to store and operate one or more applications 30 including, the content sharing mobile application 16 or a third party application 32 capable of accessing the content sharing mobile application 16. Such third party application 32 may include, but is not limited to, third party social media applications or websites. More specifically, such third party applications 32 may be configured to directly launch the user into the content sharing mobile application 16.

The content sharing mobile application 16 may include a plurality of interfaces 34. One such interface may be a profile and user group management interface 36, where the user may create their user profile and create any group the user would desire to interact with within the content sharing mobile application 16. Another interface may include a zone management interface 38, where the user may select, set, or designate boundaries of the zone or select a predetermined zone in which the shared space exists. Further, there also may be a media, creation, management and sharing interface 39, which may enable the user to create the shared space, manage, upload media content, and view the media content uploaded.

The content shared mobile application 16 may be in communication with a server 18 configured to receive and store the shared space and the media content. The server 18 may be in further communication with one or more mobile devices 20. For example, the server 18 may be in communication with a second mobile device.

In operation, the system 10 may be configured to log into the content sharing mobile application 16, established a user profile and manage one or more groups of users, set a zone, create a shared space corresponding to or associated with the zone, upload media content to the shared space, and share the media content with the second mobile device when the user is detected within the zone.

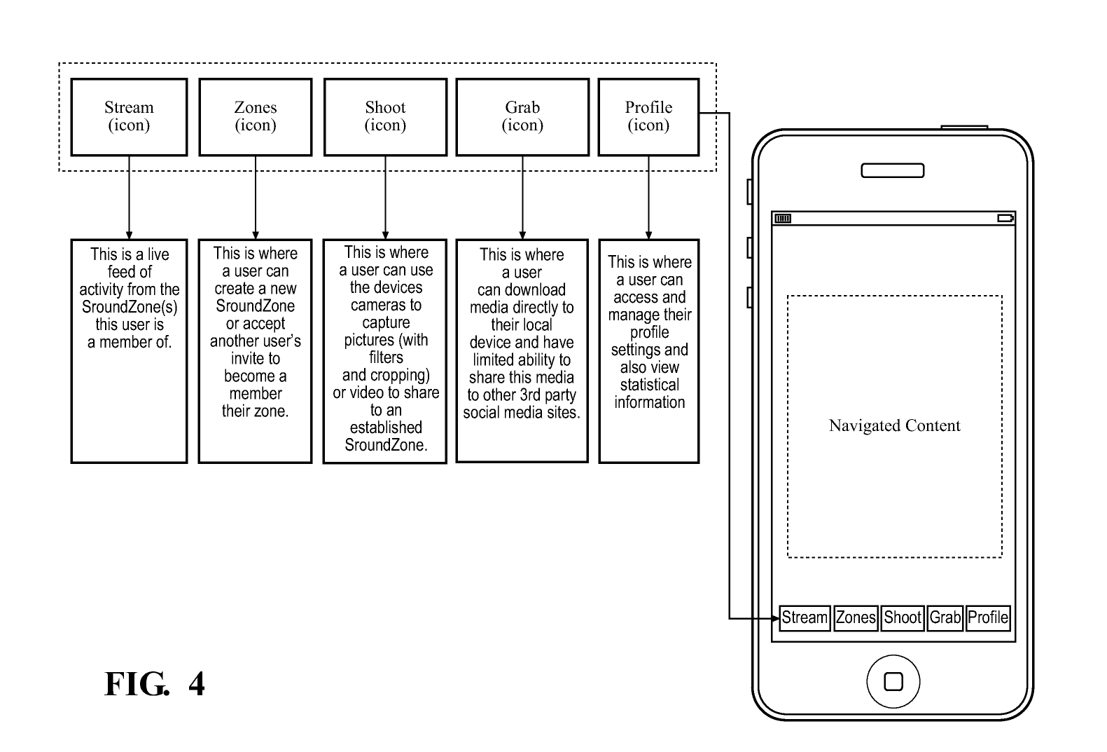

With respect to FIG. 4, an illustration of a mobile device 12 with a content sharing mobile application 16 in accordance with the present disclosure is shown. The mobile device may include a user interface 14. The user interface 14 may be configured to receive inputs from a user. The user interface 14 may be, but is not limited to, a touch screen and/or one or more buttons to select and control various settings or features on the mobile device 12. Such touch screen may be a liquid crystal display (LCD), a capacitive touch screen, or a resistive touch screen. The user interface 14 may also be configured to display media content such as, but is not limited to, text, text message, email, mobile applications, photographs, videos, music, and the like.

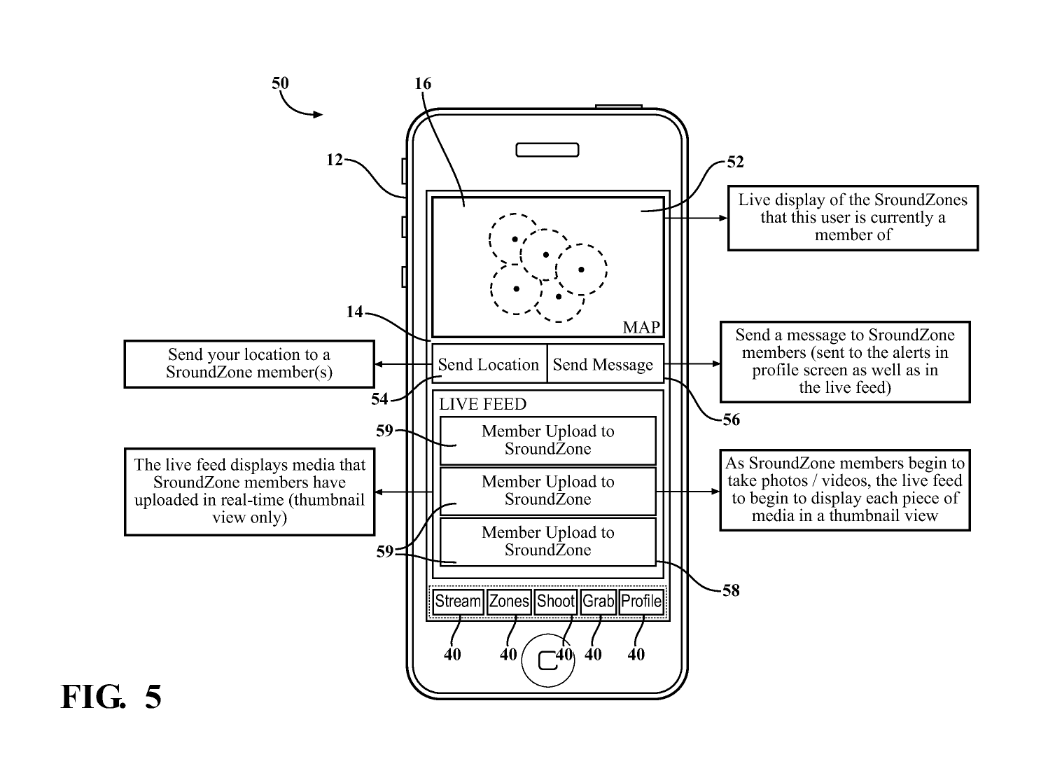

The content sharing mobile application 16 may be displayed on the user interface 14. The content sharing mobile application 16 may include one or more input icons 40 for controlling various functions and may also include a content display section 42, which may display an interface corresponding to the input icons 40. The input icons 40 may include a stream interface icon 44. The stream interface icon 44 may operate and display a live feed or real-time feed of media content shared by one or more users associated with various shared spaces the user is a part of. The input icons 40 may also include a zone user interface 46. The zone user interface 46 may be used to set or designate a zone or predetermined zone. The input icons 40 may further include a shoot interface 47, which is designed to interface with a camera of the mobile device 12 to take, filter, edit, and crop photographs or videos to upload the media content to the shared space. A grab icon 48 may also be provided and may interface with media content already stored to the mobile device 12. For example, photographs previously taken by the user. The input icons 40 may further include a profile user interface 49, which may be designed and provided to manage the user's profile settings and as well as to view statistical information related to the user profile and the content sharing mobile application 16. The input icons 40 may also be shown in FIGS. 5-6 and 8-9 to allow the user to toggle between various interfaces.

FIG. 5 is an example of an illustration of a mobile device 12 with a live stream interface 50 of a content sharing mobile application 16 in accordance with the present disclosure. When the stream screen icon 44 is selected, the live stream interface 50 may be displayed. The live stream interface 50 may include a map display 52. The map display 52 can display one or more zones that the user is detected in. The live stream interface 50 may also include a location input 54 and a messages input 56. The location input 54 may be designed to communicate with other content sharing mobile applications 16 users that are in the groups associated with the user. The message input 56 may be designed to communicate messages to viewing users, similar to a chat function. Additionally, there may be a live feed display 58, which can display a plurality of media content 59 uploaded by any user in the zone who has access to the shared space.

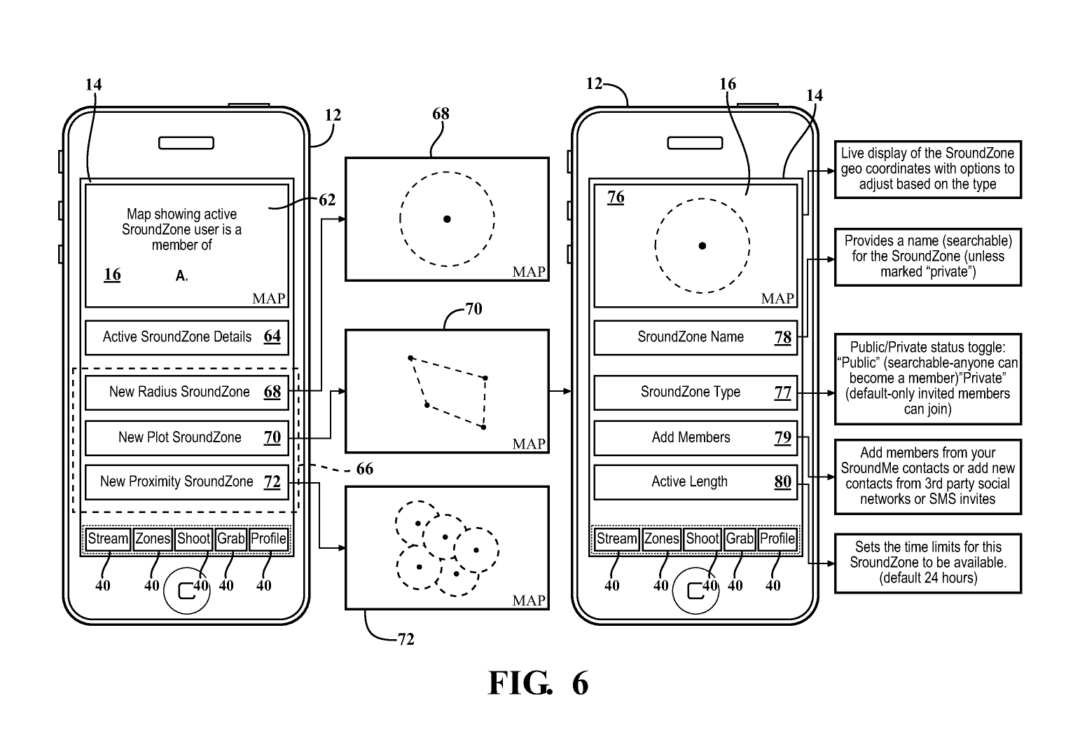

FIG. 6 is an example of an illustration of a mobile device 12 with a zone screen interface 60 of a content sharing mobile application 16 in accordance with the present disclosure. An aspect of the zone screen interface 60 may include a map display 62, which may show all zones the user is associated with or detected in. The zone screen interface 62 may also include a details display 64 configured to display information related to activated shared spaces. Such information may include, but is not limited to, names of users within the group, numbers of members, and etc. The zone screen interface 60 may further include one or more zone setting inputs 66 that form the boundary of the zone. Such zone setting inputs 66 may include 1) a radius setting 68, which may form a circle with a particular radius around the user's location; 2) a plot setting 70, which may allow the user to physically draw (with a finger or pointer) plot lines or boundaries on the map to designate the zone and hold down or pinpoint three or more points on the map to designate the zone; and 3) a proximity setting 72, which may set boundaries based on the proximity of two or more users to one another. For example, if two or more users are two miles away from one another, the proximity setting 72 can create a multiple boundaries to surround them. Once the zone is designated, the creation interface 74 may be displayed. The creation interface 74 may include a map display 76 to show the zones the user is detected in. A group name display 78 can also provide a searchable name to share the search associated with a zone unless the shared space is designated as private.

The creation interface 74 may further include a status input 77 or toggle. The status input 77 may be designed to allow the user to select whether the shared space is public or accessible to all user of the content sharing mobile application 16 detected within the zone or private and accessible to only those assigned to the shared space when they are within the zone.

Another aspect of the creation interface 74 may include a member input 79 that can enable the user to add, invite, or assign users to upload or view the media content to the shared pace. The member input 79 may be designed to access the user's contracts on their mobile device 12 or may access the user's contacts from their third party social media profile.

According to a further aspect, the creation interface 74 may include a time limit input 80. The time limit input 80 may be designed to allow the user to set a time limit or restriction on the shared space. The time limitation may be selected by the user or a default setting may be selected. The default setting can be 24 hours.

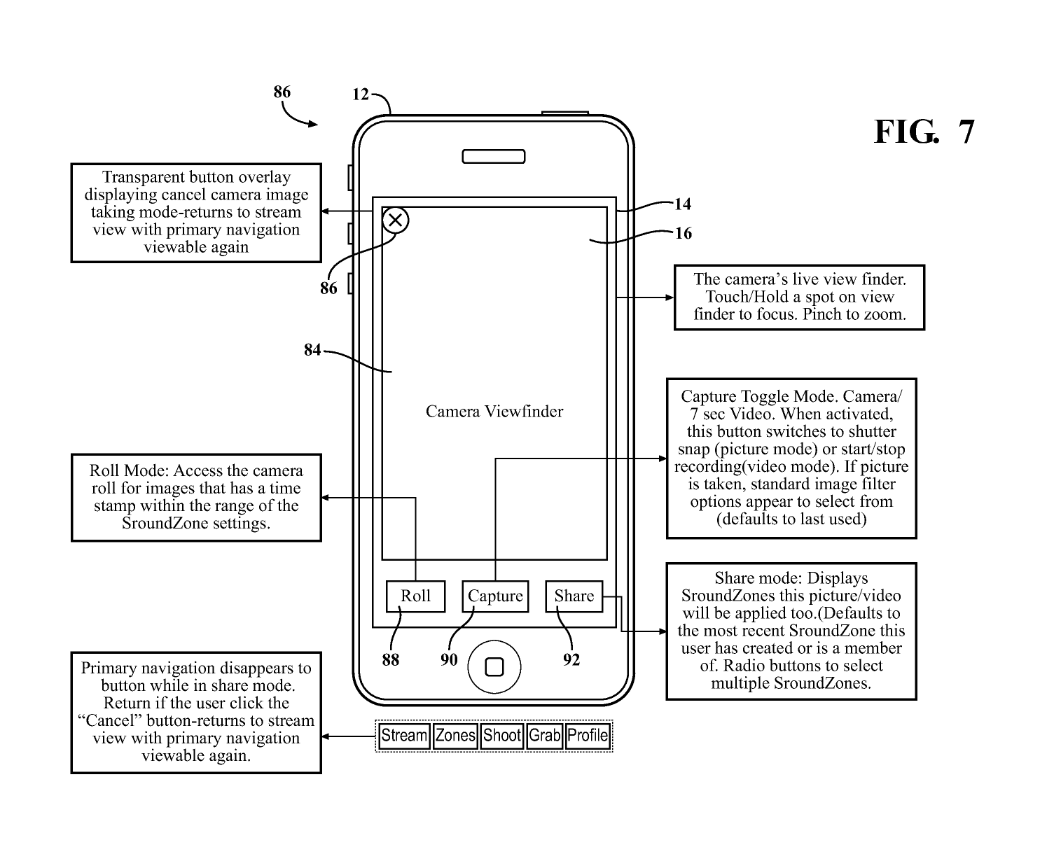

FIG. 7 is an example of an illustration of a mobile device 12 with a shoot interface 82 of a content sharing mobile application 16 in accordance with the present disclosure. The shoot interface 82 may include a camera view window 84 that allows the user to take, focus, and zoom in for photographs or videos. There may also be a cancel button 86 located within the camera view window 84 to allow the user to exit the shoot interface 82. The cancel button 86 may be an “X”. The shoot interface 82 may further include a roll input 88, a capture input 90, and a share input 92. The roll input 88 may be provided to access the camera roll for photographs or videos that have been taken and time stamped when the user has been present within the designated zone associated with the shared space. The capture input 90 may be used to take photographs or record videos. If a photograph is taken, the photograph may be filtered, edited, or cropped in this interface 82. Additionally, the share input 92 may allow the user to share the photograph or video with the share space and users associated with the shared space. Unlike FIGS. 4-6, the inputs icons 40 may not be provided.

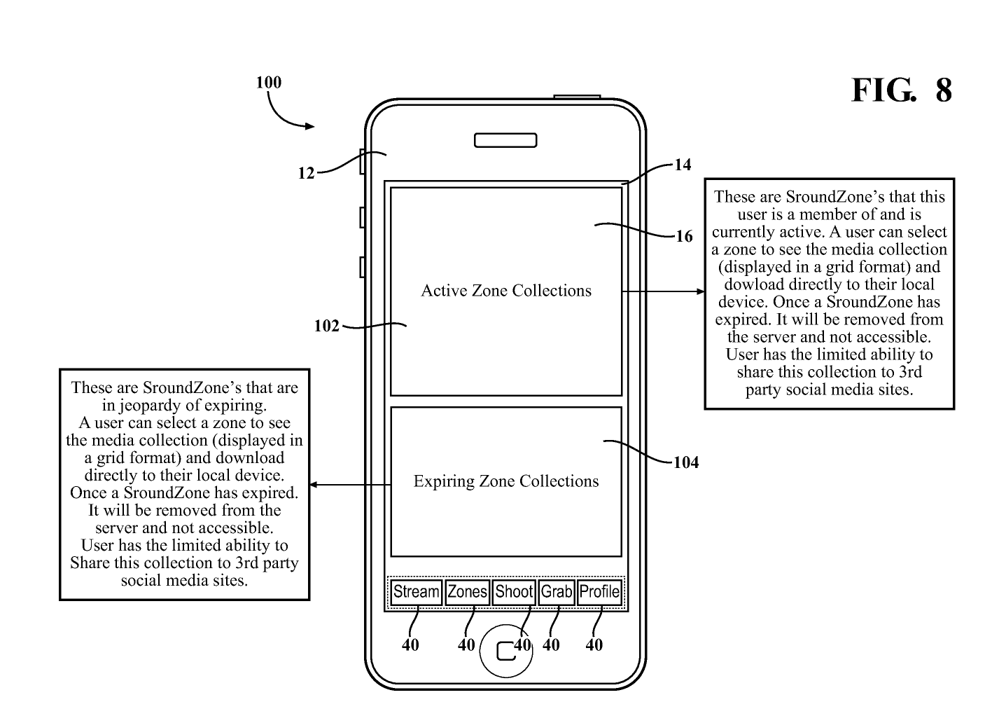

FIG. 8 is an example of an illustration of a mobile device 12 with a grab interface 100 of a content sharing mobile application 16 in accordance with the present disclosure. According to an aspect, the grab interface 100 can include an active zone display 102 and an expiring zone display 104. The active zone display 102 may show the zones in which the user is currently detected in and which other zones and shared spaces the user is a group member of. The active zone display 102 can allow the user to select the zone to see a media content collection (i.e. all media shared within the shared space and zone) and download directly to the mobile device 12. The active zone display 102 may further be configured to limit the ability to share the media content collection with third party social media applications and websites. With respect to the expiring zone display 104, media content may expire and may be erased over time. In particular, media content from previous zones and shared spaces as well as media content from shared spaces with time limitations may expire and may be erased. Similar to the active zone display 102, the expiring zone display 104 may also allow the user to select the zone to see the media content collection and download directly to the mobile device 12 and may also limit the ability to share the media content collection with third party social media applications or websites. However, once the media content has expired, the media content will be removed from the system's 10 server 18 and may not be accessible by the content sharing mobile application 16. Additionally, the input icons 40 may be displayed within the grab interface 100 of the content sharing mobile application 16.

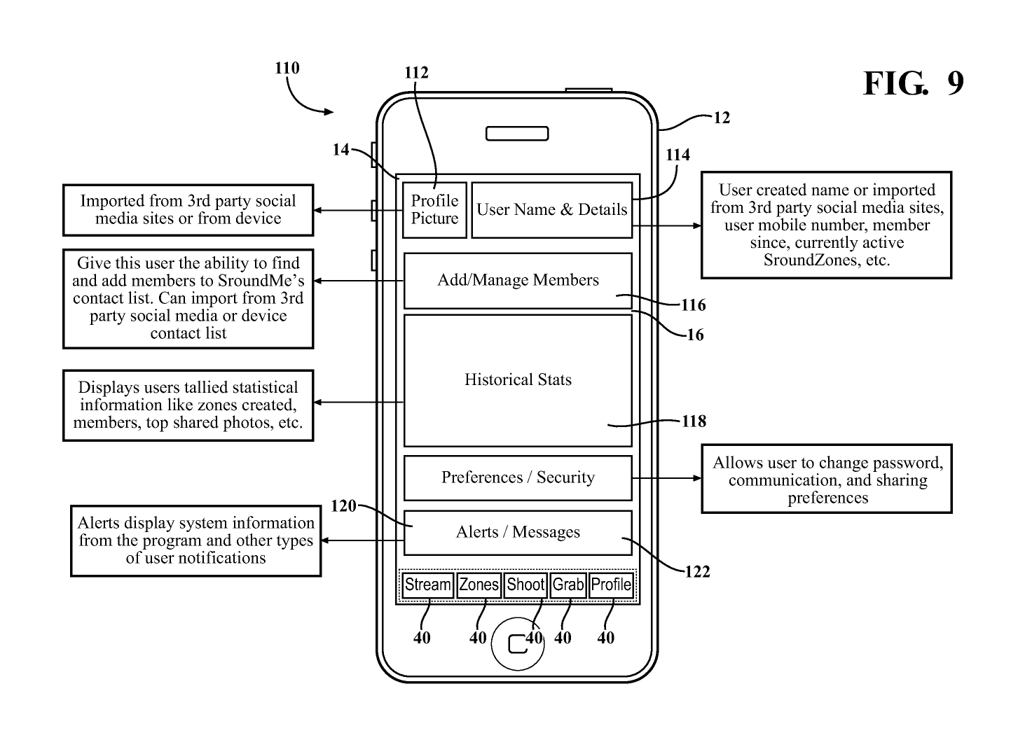

FIG. 9 is an example of an illustration of a mobile device 12 with a profile interface 110 of a content sharing mobile application 16 in accordance with the present disclosure. According to an aspect of the present disclosure, the profile interface 110 may include a 1) profile picture display 112, which may be imported from the mobile device 12 or from a third party social media application or website; 2) a user name section 114, where the user may designate their own name or import their name from a third party social media application and site; 3) an add/manage members input 116, which allows the user to find and add member (i.e. friends or contacts) to the content sharing mobile application 16 for use in conjunction shared spaces; 4) a historical statistics display 118, which may show information such as number of zones created, users, top shared media content, and the like; 5) a security input 120 that may allow the use to change passwords, communication, and sharing preferences; and 6) an alerts display 122 that may inform the user of different notifications and information related to the program such as software updates, user information, new posts to the shared space and the like.

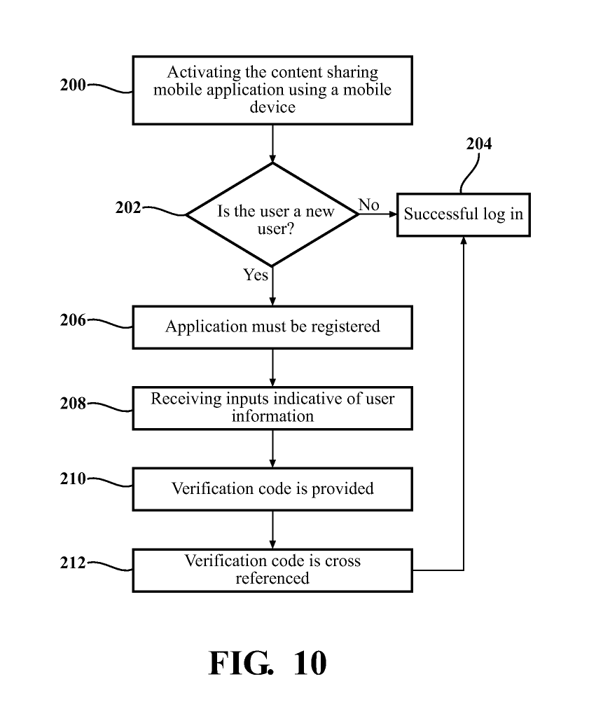

With respect to FIG. 10, a flowchart of a method of accessing a content sharing mobile application in accordance with the present disclosure is shown. In particular, the method may include activating the content sharing mobile application using a mobile device 200. The content sharing mobile application may be activated through the selection of the actual application or through a third party application or website. After the content sharing mobile application is activated, the content sharing mobile application may designate whether the user is a new user 202. If the user is designated as not a new user, then the user may successfully log in and may start sharing media content with other users 204. If the user is designated to be a new user, then the user may register with the content sharing mobile application 206.

The method may further include receiving inputs indicative of user information such as, but is not limited to; a phone number or email address 208 and the content sharing mobile application may provide a verification code in response to the user information provided 210. The verification code may then be crossed referenced by the application to ensure authenticity 212 and the user may be logged in to the content sharing mobile application.

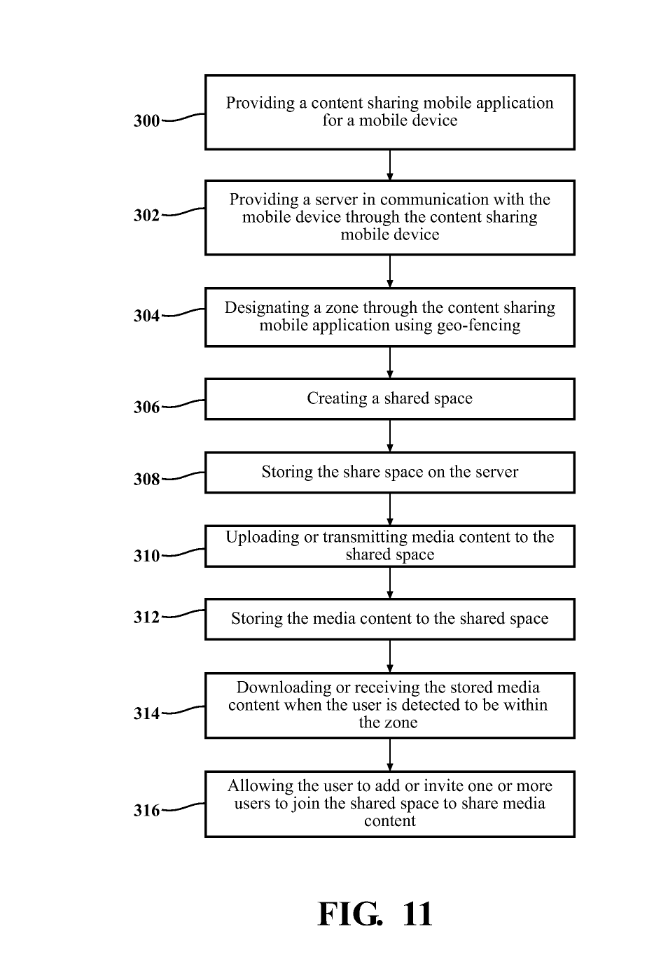

FIG. 11 is a flowchart of a method of sharing media content in accordance with the present disclosure. The method may include providing a content sharing mobile application for a mobile device 300. The content sharing mobile application may be displayed on a user interface of the mobile device. A server in communication with the mobile device through the content sharing mobile application may also be provided 302. The method may also include designating a zone through the content sharing mobile application through the user interface of the mobile device 304. The zone may be designated through the use of geo-fencing or GPS technology as described above, and may be drawn in the various forms described above. Once the zone is designated, a shared space may be created 306 and the shared space may then be stored on the server 308. The method may further include uploading or transmitting media content to the shared space 310 and storing the media content to the server 312. Once the media content is stored to the server, the media content may be transmitted to, downloaded, or received by another user through a mobile device with the content sharing mobile application when the user is detected to be within the zone 314. The media content may be available and accessed for a period of time when the user is within the zone.

Another aspect of the method may also include allowing the user to add or invite one or more users to join the shared space to share media content when the user is detected to be within the zone 316.

While the present disclosure has focused on creating a shared space to share media content between users of mobile devices and sharing the media content based on the zone the users are detected in, the system and mobile application may additionally be configured to create a shared space based on an event which may take place. For example, the event may be a concert. The shared spaced may be accessible when the user is detected at the event or within the location or zone the event is being held at.

While examples of the disclosure have been illustrated and described, it is not intended that these examples illustrate and describe all possible forms of the disclosure. Rather, the words used in the specification are words of description rather than limitation, and it is understood that various changes may be made without departing from the spirit and scope of the disclosure. Additionally, the features and various implementing embodiments may be combined to form further examples of the disclosure.

What is claimed:

1. A content sharing mobile application for sharing media content between at least two users, comprising:
a media, creation, management, and sharing interface for creating a shared space for transmitting media content between the at least two users; and
a zone management interface for setting a zone in which the shared space exists,
wherein each of the users are able to upload media content to the shared space and to view media content within the shared space when the users are determined to be located within the zone.

2. The content sharing mobile application of claim 1, further comprising:
a profile and user group management interface for allowing the at least two users to create a user profile for operating the content sharing mobile application.

3. The content sharing mobile application of claim 1, wherein the media content includes one of a text, text message, e-mail, photograph, video, and music.

4. The content sharing mobile application of claim 1, wherein the media, creation, management, and sharing interface includes a plurality of icons for controlling and interacting with the shared space.

5. The content sharing mobile application of claim 4, wherein the plurality of icons includes a stream interface icon for enabling live streaming within the shared space.

6. The content sharing mobile application of claim 4, wherein the plurality of icons includes a shoot interface icon for taking, filtering, editing, and cropping photographs and video.

7. The content sharing mobile application of claim 4, wherein the plurality of icons includes a status input for selecting whether the shared space is private.

8. The content sharing mobile application of claim 1, wherein setting the zone includes selecting a predetermined location from a list of locations and wherein the list of location is generated using GPS on the mobile device.

9. The content sharing mobile application of claim 1, wherein setting the zone includes setting a boundary around a location using geo-fencing technology on the mobile device.

10. A method for sharing media content between at least two users, each user having a mobile device equipped a content sharing mobile application, the method comprising:
creating a shared space for sharing and viewing media content through the content sharing mobile application on the mobile device, wherein media content is transmitted between the at least two users through the shared space when at least one of the user's is within a designated zone; and
allowing the at least one of the two users to access and view the media content when they are detected to be within the designated zone.

11. The method of claim 10, wherein the at least two users includes a sending user and a receiving user, and wherein the sending user creates the shared space when the sending user is within the designated zone.

12. The method of claim 10, further comprising:
setting the designated zone such that the at least two users will have access to the shared space when either are detected within the zone.

13. The method of claim 12, wherein setting the designated zone includes selecting a predetermined location from a list of locations and wherein the predetermined location is determined using GPS location on the mobile device.

14. The method of claim 12, wherein setting the designated zone includes setting a boundary using geo-fencing technology on the mobile device.

15. The method of claim 10, further comprising:
receiving media content uploaded to the shared space by one of the at least two users; and
transmitting the media content to the users to view when either of the users are determined to be within the designated zone.

16. The method of claim 1, wherein the shared space is private such that only users invited to view the shared space can access media content when they are determined to be within the designated zone.

17. A system for sharing media content between at least two users, comprising:
a mobile device having a user interface;
a content sharing mobile application stored on the mobile device, the content sharing mobile application having a shared space for transmitting media content between the at least two users when the users are located within a designated zone, and
a server for storing the shared space and media content associated with the shared space.

18. The system of claim 17, wherein one of the at least two users creates the shared spaced through the user interface on the mobile device when the user is located within the designated zone.

19. The system of claim 17, wherein the designated zone is selected by one of the at least two users via the user interface on the mobile device.

20. The system of claim 17, wherein the shared space shares media content between the at least two users for a predetermined amount of time.
